(19) United States
(12) Patent Application Publication
(10) Pub. No.: US 2014/0102231 A1
(43) Pub. Date: Apr. 17, 2014

(54) THREADED ROD RECIPROCATION INNER ROTOR DIRECT DRIVE MECHANISM

(71) Applicant: HIWIN MIKROSYSTEM CORP., Taichung City (TW)

(72) Inventor: Yung-Tsai CHUO, TAICHUNG CITY (TW)

(73) Assignee: HIWIN MIKROSYSTEM CORP., TAICHUNG CITY (TW)

(21) Appl. No.: 13/672,986

(22) Filed: Nov. 9, 2012

(30) Foreign Application Priority Data
Oct. 17, 2012 (TW) 101138169

(51) Int. Cl. F16H 25/22; F16H 25/20

(52) U.S. Cl. CPC F16H 25/2204; F16H 25/20
USPC 74/89.34

(57) ABSTRACT

A threaded rod reciprocation inner rotor direct drive mechanism is provided. The threaded bush of the threaded rod set serves as the rotary shaft of the rotor section of the inner rotor torque motor. A part of the threaded rod set is a part of the inner rotor torque motor. Accordingly, the blind spot of the conventional technique is overcome to reduce the number of the components and minify the total volume and simplify the assembling and processing procedure.

### BACKGROUND OF THE INVENTION

1. Field of the Invention

The present invention relates generally to a transmission technique, and more particularly to a threaded rod reciprocation inner rotor direct drive mechanism.

2. Description of the Related Art

It is known that a motor can be used to drive a threaded rod to linearly reciprocally move. A proper transmission component is disposed between the output shaft of the motor and a threaded bush, whereby the power of the motor is indirectly transmitted to the threaded bush for rotating the threaded bush. At this time, the threaded rod coaxially screwed in the threaded bush is linearly reciprocally moved.

FIG. 1 shows a conventional threaded rod reciprocation mechanism. The motor 1 has a tubular rotor 2, which is drivingly connected to a threaded bush 4 via a gear section 3. When the rotor 2 rotates, the threaded bush 4 is driven by the rotor 2 via the gear section 3 to synchronously rotate. At this time, the threaded rod 5 coaxially screwed in the threaded bush 4 is linearly reciprocally moved.

FIG. 2 shows another conventional threaded rod reciprocation mechanism free from the gear section. In this threaded rod reciprocation mechanism, a threaded bush 6 is directly coaxially fixedly connected with one end of a tubular rotor 7 by means of a fixing structure. When the rotor 7 rotates, through the fixing structure, the threaded bush 6 is driven by the rotor 7 to synchronously rotate. At this time, the threaded rod 8 coaxially screwed in the threaded bush 6 is linearly reciprocally moved.

In comparison with the traditional threaded rod reciprocation mechanism in which the threaded bush is indirectly driven to linearly reciprocally move via an external reducing gear set, in the above threaded rod reciprocation mechanism, the threaded rod is coupled with the motor without using any external reducing gear set. Therefore, the total volume is minified and the transmission loss is reduced. However, in the conventional technique, there is a technical blind spot that the threaded bush and the threaded rod are always treated as a set of components. That is, the threaded bush is still treated as a component independent from the motor. Under this technical blind spot, the threaded bush is always indirectly driven by the motor to rotate for linearly reciprocally moving the threaded rod. No matter whether the threaded bush is connected to the rotor of the motor via a gear or is serially connected to the rotor of the motor, the number of the components is increased. As a result, the assembling and processing procedure is complicated to lead to increase of manufacturing cost.

### SUMMARY OF THE INVENTION

It is therefore a primary object of the present invention to provide a threaded rod reciprocation inner rotor direct drive mechanism. The threaded bush coaxially screwed on the threaded rod directly serves as the rotary shaft of the rotor section of the inner rotor torque motor. Accordingly, the blind spot of the conventional technique is overcome to reduce the number of the components and minify the total volume and simplify the assembling and processing procedure.

To achieve the above and other objects, the threaded rod reciprocation inner rotor direct drive mechanism of the present invention includes: an inner rotor torque motor having a body section, an annular stator section disposed in the body section and a rotor section coaxially disposed in the stator section; and a threaded rod set including a tubular threaded bush and a threaded rod coaxially screwed in the threaded bush. The threaded rod reciprocation inner rotor direct drive mechanism is characterized in that the threaded bush serves as a rotary shaft of the rotor section and multiple magnets of the rotor section are attached to outer circumference of the threaded bush in adjacency to and corresponding to the stator section.

In the above threaded rod reciprocation inner rotor direct drive mechanism, the threaded rod set further includes multiple ball members positioned between the threaded bush and the threaded rod. The ball members are rollably inlaid in thread grooves formed on inner circumference of the threaded bush and thread grooves formed on outer circumference of the threaded rod corresponding to the thread grooves of the threaded bush.

The present invention can be best understood through the following description and accompanying drawings, wherein:

### BRIEF DESCRIPTION OF THE DRAWINGS

FIG. 1 is a sectional view of a conventional threaded rod reciprocation mechanism;

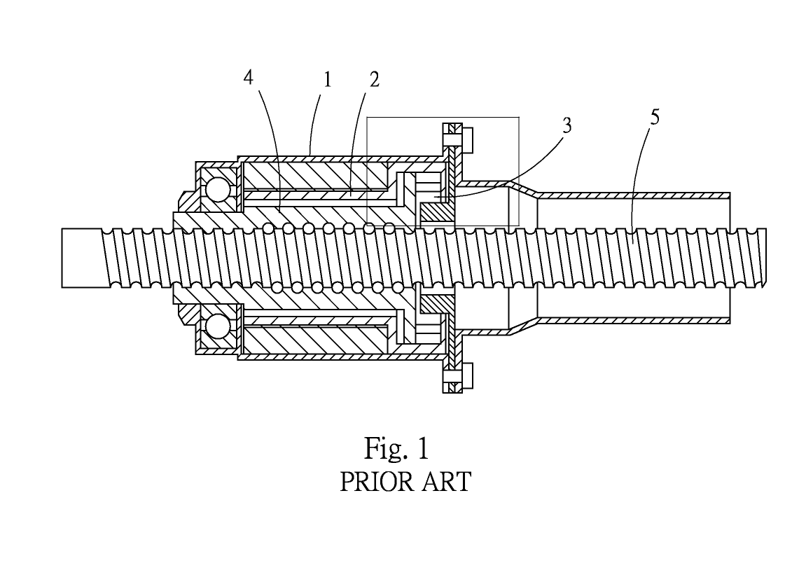

FIG. 2 is a sectional view of another conventional threaded rod reciprocation mechanism;

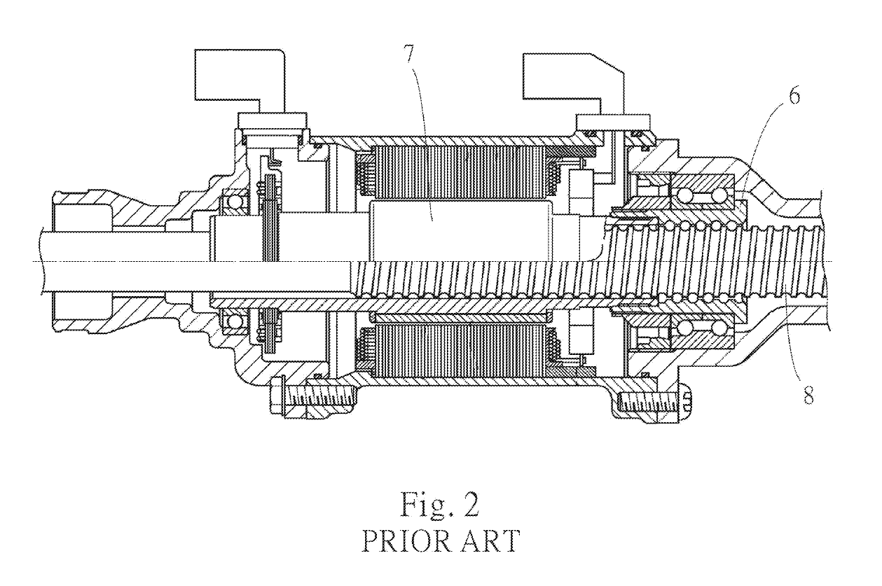

FIG. 3 is a perspective assembled view of a preferred embodiment of the present invention; and

FIG. 4 is a sectional assembled view of the preferred embodiment of the present invention.

### DETAILED DESCRIPTION OF THE PREFERRED EMBODIMENTS

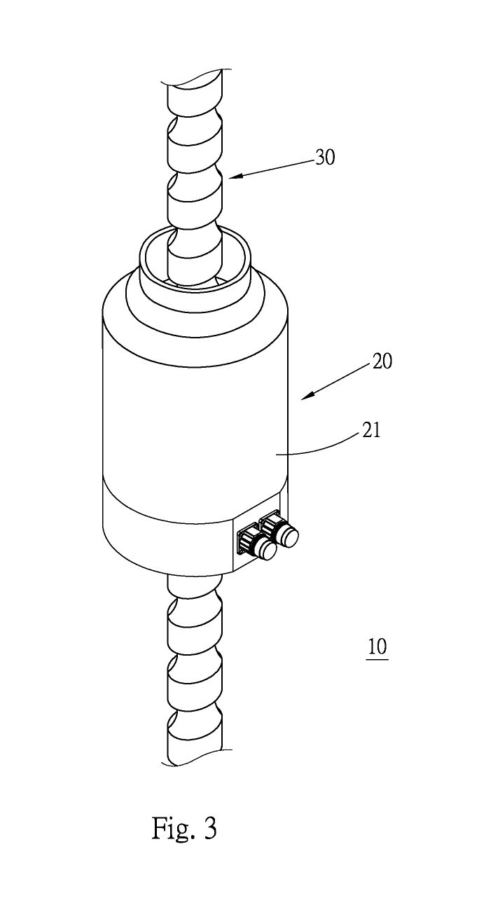

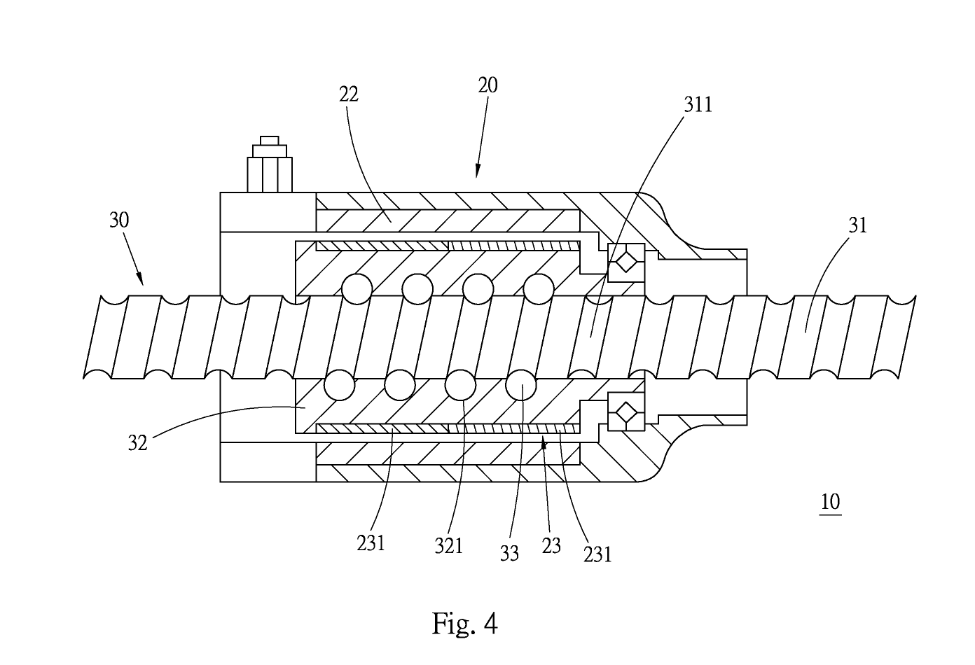

Please refer to FIGS. 3 and 4. According to a preferred embodiment, the threaded rod reciprocation inner rotor direct drive mechanism 10 of the present invention includes an inner rotor torque motor 20 and a threaded rod set 30.

The inner rotor torque motor 20 is a conventional direct drive motor employing electromagnetic technique for creating rotational movement. To speak more specifically, the inner rotor torque motor 20 has a body section 21 in the form of a housing, an annular stator section 22 having windings for creating varying magnetic field and a rotor section 23 disposed in the stator section 22 and having multiple permanent magnets 231 for creating fixed magnetic field. When the stator section 22 is powered on, the stator section 22 creates varying magnetic field to drive the rotor section 23 to rotate.

In this embodiment, the threaded rod set 30 is, but not limited to, a conventional ball threaded rod. Alternatively, the threaded rod set 30 can be a conventional Acme threaded rod. To speak more specifically, the threaded rod set 30 includes a threaded rod 31, a tubular threaded bush 32 coaxially screwed on the threaded rod 31 and multiple ball members 33 positioned between inner circumference of the threaded bush 32 and outer circumference of the threaded rod 31. The ball members 33 are rollably inlaid in the thread grooves 321 formed on the inner circumference of the threaded bush 32 and the thread grooves 311 formed on the outer circumference of the threaded rod 31 corresponding to the thread grooves 321 of the threaded bush 32. Accordingly, the threaded rod 31 and the threaded bush 32 are axially movable relative to each other along the axis of the threaded rod 31.

The present invention is mainly characterized in that the threaded bush 32 is coaxially positioned in the stator section 22 and the magnets 231 of the rotor section 23 are sequentially fixedly attached to the outer circumference of the threaded bush 32. Accordingly, the threaded bush 32 serves as the rotary shaft of the rotor section 23.

According to the above arrangement, in the threaded rod reciprocation inner rotor direct drive mechanism 10, a part of the threaded rod set 30 is a part of the inner rotor torque motor 20. Therefore, after powered on, under electromagnetic force, the inner rotor torque motor 20 can directly drive the threaded bush 32 to rotate. Through the rolling ball members 33, the threaded bush 32 drives the threaded rod 31 to axially linearly reciprocally move. The threaded rod reciprocation inner rotor direct drive mechanism 10 is applicable to various fields. For example, the threaded rod reciprocation inner rotor direct drive mechanism 10 can be used in a vehicle power steering system.

In comparison with the conventional technique, in the threaded rod reciprocation inner rotor direct drive mechanism 10 of the present invention, the threaded rod set 30 is changed from a passive state to an active state to overcome the blind spot of the conventional technique. Moreover, by means of the technical characteristic of the present invention, the number of the components is reduced and the assembling and processing procedure is simplified. Also, the volume is minified. With respect to a vehicle power steering system, the threaded rod reciprocation inner rotor direct drive mechanism 10 of the present invention can be installed in a narrow space. Furthermore, at the present time, when energy resources are increasingly scarce, the threaded rod reciprocation inner rotor direct drive mechanism 10 of the present invention catches up with the trend to lightweight of vehicles.

The above embodiments are only used to illustrate the present invention, not intended to limit the scope thereof. Many modifications of the above embodiments can be made without departing from the spirit of the present invention.

What is claimed is:

1. A threaded rod reciprocation inner rotor direct drive mechanism comprising:
an inner rotor torque motor having a body section, an annular stator section disposed in the body section and a rotor section coaxially disposed in the stator section; and
a threaded rod set including a tubular threaded bush and a threaded rod coaxially screwed in the threaded bush, the threaded rod reciprocation inner rotor direct drive mechanism being characterized in that the threaded bush serves as a rotary shaft of the rotor section and multiple magnets of the rotor section are attached to outer circumference of the threaded bush in adjacency to and corresponding to the stator section.

2. The threaded rod reciprocation inner rotor direct drive mechanism as claimed in claim 1, wherein the threaded rod set further includes multiple ball members positioned between the threaded bush and the threaded rod, the ball members being rollably inlaid in thread grooves formed on inner circumference of the threaded bush and thread grooves formed on outer circumference of the threaded rod corresponding to the thread grooves of the threaded bush.
